(19) United States
(12) Patent Application Publication
(10) Pub. No.: US 2012/0009066 A1
(43) Pub. Date: Jan. 12, 2012

(54) DRIVE DEVICE FOR A WIND TURBINE

(76) Inventors: Reinhard Vilbrandt, Rostock (DE); Christian Läritz, Heiligenhagen (DE); Olaf Willauschus, Bad Doberan (DE)

(21) Appl. No.: 13/256,995

(22) PCT Filed: May 13, 2009
(86) PCT No.: PCT/EP2009/003403

§ 371 Date: Sep. 16, 2011

(30) Foreign Application Priority Data
Mar. 18, 2009 (DE) 10 2009 013 311.9

(51) Int. Cl. F03D 7/00

(52) U.S. Cl. 416/153

(57) ABSTRACT

A driving device for a rotor blade of a wind turbine has an asynchronous machine (6) for adjusting the rotor blade, an electrically operable brake (5) disposed at the driving unit for fixing or braking the driving unit and an electrical supplying device (2), via which the asynchronous machine is connectable with a three-phase power supply network. The supplying device comprises a rectifier (21), an inverted rectifier (23) and a direct-voltage intermediate circuit. A direct-voltage regulator (24) is provided which is connected with the intermediate circuit, via which the brake is electrically supplied. By supplying the brake by the intermediate circuit, an additional voltage source for the brake can be spared and the brake can be implemented extremely simply.

### FIELD OF THE INVENTION

The present invention relates to a driving device for a rotor blade of a wind turbine. Such wind turbine comprises a rotor with a hub, and the rotor is rotatably disposed at a machine room, wherein the rotor comprises at least one electromechanical driving device for adjusting the Angle Of Attack of at least one rotor blade which is fixable at the hub. This driving device comprises an asynchronous machine for adjusting the rotor blade, an electrically operable brake disposed at the driving unit, for fixing or braking the driving unit, and an electrical supplying device, via which the asynchronous machine is connectable with a three-phase power supply network. The supplying device comprises a rectifier, an inverted rectifier and a direct-voltage intermediate circuit. Usually, a dedicated driving device is provided for each rotor blade of a wind turbine. In case of emergency, such as failure of components or the voltage supply, an emergency operation supplying device for adjusting the rotor blades into an operationally safe position (for example vane position) is normally provided.

### BACKGROUND OF THE INVENTION

A traditional electrical driving device is described in DE 103 35 575 B4. The blade adjustment is based on three-phase a. c. motors and frequency converters. The frequency converter is powered by three-phase alternating current and provides a direct-voltage intermediate circuit via rectifier. From this, the inverted rectifier for controlling the three-phase a. c. motors is then powered. Normally, an electrical energy storage, which powers the intermediate circuit, is provided for an emergency supply.

Here, the disadvantage thereof is that a plurality of different electrical components are necessary so as to be able to safely drive a driving system with an asynchronous machine, a brake and/or an emergency operation supplying device. Since the installation space in the wind turbine, especially in the hub, is limited, the plurality of electrical components especially appears to be disadvantageous.

### SUMMARY OF THE INVENTION

The problem of the present invention is to propose an improved driving system for a wind turbine, and a wind turbine with such a driving system for adjusting the rotor blade, wherein the disadvantages of the prior art are avoided.

The problem is solved with the features of claim 1 according to the present invention, by providing a direct-voltage regulator which is connected with the intermediate circuit, via which the brake is electrically powered. By powering the brake via the intermediate circuit, an additional voltage source for the brake can be avoided and the brake can be implemented extremely simply.

A further embodiment is disclosed that an emergency operation supplying device is connected with the intermediate circuit and can be charged from the intermediate circuit by means of a charging unit and a charging control system. Thus, a further voltage source for charging the emergency operation supplying device becomes redundant.

Furthermore, a control unit for controlling the direct-voltage regulator and/or the charging control system is provided. The charging control system can be directly integrated into the control unit.

The control unit can be connected with at least one temperature sensor and/or humidity sensor, and moreover, at least an air conditioning device and/or a heating device is provided for cooling or warming the supplying device and/or the emergency operation supplying device, wherein the air conditioning device and/or the heating device is controllable by the control unit.

A particular beneficial embodiment of the present invention is disclosed that a physical unitary inverter unit is provided, in which the supplying device, the direct-voltage regulator, the charging unit, the charging control system and the control unit are disposed. Thereby, the component complexity of the driving system is considerably reduced, whereby the cost of the production and the assembly and the error-proneness is also clearly reduced.

The present invention also discloses an inverter unit comprising a rectifier, an inverted rectifier, a direct-voltage intermediate circuit, wherein the intermediate circuit can be powered via the rectifier, and wherein an asynchronous machine of a driving unit of a blade adjusting means of a wind turbine can be powered via the inverted rectifier, further comprising a direct-voltage regulator for controlling an electrically operable brake for the driving unit, and a control unit for controlling the inverted rectifier and the direct-voltage regulator, wherein the inverter unit in combination with the rectifier, the inverted rectifier, the direct-voltage intermediate circuit, the direct-voltage regulator and the control unit is implemented as a physical unit.

Another embodiment is disclosed that the physical unit of the inverter unit comprises a charging unit and a charging control system for charging and monitoring an external emergency operation supplying device. Here, the physical unit can comprise a temperature sensor and a humidity sensor for monitoring the internal environment. Moreover, further inputs for additional temperature sensors and/or humidity sensors can be provided.

The present invention also comprises a wind turbine with a machine room disposed on a tower and with a rotor rotatably disposed at the machine room, the wind turbine comprising a hub and rotor blades rotatably disposed at the hub, wherein at least one driving device as described in the above is disposed in the hub.

### BRIEF DESCRIPTION OF THE DRAWINGS

The other details of the present invention come from the drawings in the view of the specification. In the drawings:

FIG. 1 shows a schematic diagram of a hub of the wind turbine with the driving device, and

FIG. 2 shows a simplified wiring plan and layout plan of the driving device.

### DETAILED DESCRIPTION OF EMBODIMENTS

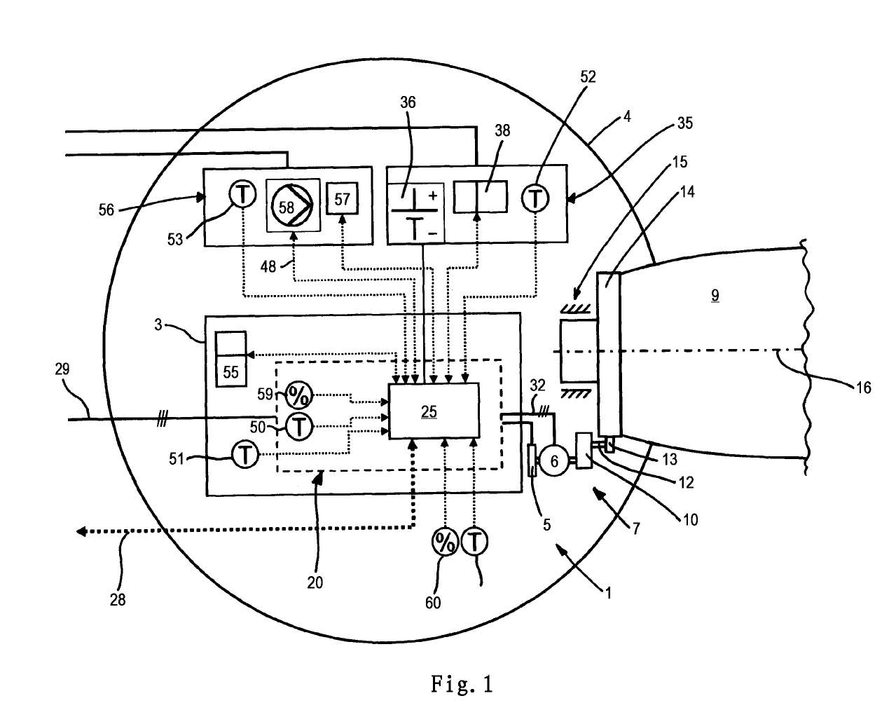

FIG. 1 shows an embodiment of the driving device 1 according to the present invention, wherein an inverter unit 20 is disposed in a switch cabinet 4 in a hub 3 of a not-shown wind turbine. The inverter unit 20 powers the asynchronous machine 6 of the driving unit 7 of the blade adjusting means of a rotor blade 9 via electrical connector 32. The driving unit 7 can have a gear 10, wherein the driving shaft 11 of the gear 10 is directly connected with the asynchronous machine 9 and the driven shaft 12 is connected with a pinion 13. The pinion 13 gears into a sprocket 14 which is torque-proof connected with the rotor blade 9, wherein the rotor blade 9 is mounted in the hub 4 via a blade bearing 15 and is rotatable around its longitudinal axis.

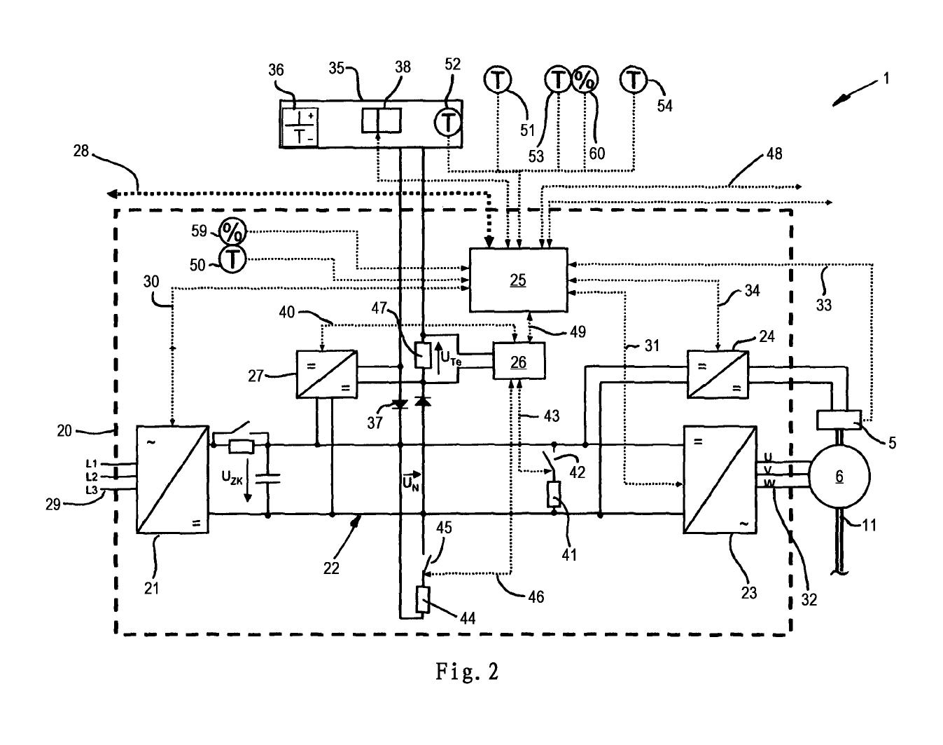

FIG. 2 shows the inverter unit 20 of the driving system 1 schematically. Here, the asynchronous machine 6 is connected with a supply network 10 via an electrical supplying device 2. The inverter unit 20 comprises the electrical supplying device 2 with a rectifier 21, a direct-voltage intermediate circuit 22 and an inverted rectifier 23, a direct-current-voltage regulator 24, a control unit 25, a charging control system 26 and a charging unit 27. This inverter unit 20 is implemented as physical unit in a compact manner. The control unit is connected with the control means of the wind turbine via connector 28.

The rectifier 21 is connected with a three-phase supply network 29 and provides a direct current voltage U_{ZK} in the intermediate circuit 22. Here, the rectifier 21 can be actively controlled by the control unit 25 via connector 30. A passive implementation of the rectifier is also considerable. The inverted rectifier 23 provides the asynchronous machine 6 with a suitable supply with three-phase alternating current via the connector 32. Here, the inverted rectifier 23 is controllable by means of connector 31 of the control unit 25 of the inverter unit 20. The control unit 25 also indicates the inverted rectifier 23 how the asynchronous machine 6 is operated according to the requirement. Furthermore, a giver can be provided at the driving unit 7, and the giver reports the position of the rotor blade 9 back to the control unit 25 via connector 33. So the control unit 25, the driving unit 7 and the giver together are adapted to represent a control loop for adjusting the blade.

In order to be able to maintain a defined desired position of the rotor blade 9 without permanently controlling the asynchronous machine 6, or also in order to brake the driving unit 7 and the rotor blade 9, an electromechanical brake 5 is disposed at the driving unit 7. This brake 5 can directly impinge on a shaft 11 of the asynchronous machine 6 or of the gear 10 and be disposed there.

A fail-safe implementation is realized in a way that in the currentless status in the brake 5 a non-rotating friction means impinges on a brake disk or brake drum, which is torque-proof connected with the shaft 11, wherein a spring means presses the friction means against the brake disk or brake drum. The normal force resulted therefrom produces the desired braking or holding torque. Preferably, the brake 5 is disposed at the fast shaft 11 of the gear 10.

Preferably, the brake 5 has an electromechanical operating element with a coil, and the electromechanical operating element is adapted to raise the friction means from the brake disk or brake drum against the spring force of the spring means. In order to release the brake 5, the coil in the brake 5 must be powered by the direct-current-voltage regulator 24. Further, the direct-current-voltage regulator 24 is so controlled by the control unit 25 via connector 34 that the direct-current-voltage regulator 24 absorbs electric energy from the direct-current-voltage intermediate circuit 22 and applies a release voltage U_{L} at the coil of the brake 5. The direct-current-voltage regulator 24 is so designed that the direct-current-voltage regulator 24 provides a constant release voltage U_{L} independent of the voltage U_{ZK} in the intermediate circuit. Thereby, a safe release of the brake 5 is possible.

It can be particularly important that if emergency occurs, that the three-phase power supply network 10 does not provide electric energy for the supplying device 2 or the inverter unit 20 any more (for example, failure of supply network), the rotor blades 9 must be brought into a neutral position. In this case, the intermediate circuit 22 is powered by an emergency operation supplying device 35 which is directly connected with the intermediate circuit 22. If the level of the emergency voltage U_{N} of the emergency operation supplying device 35 is not enough to release the brake 5, the rotor blades 9 may not be moved to a neutral position any longer. Thereby, a damage of the whole equipment would be possible. If the direct-current-voltage regulator 24 is implemented as upward-regulator, the brake 5 can be released despite of the low voltage.

Furthermore, the direct-current-voltage regulator 24 can be so implemented that it can provide different but respectively constant release voltages for different brakes in different types of wind turbines. Thereby, the driving device 1 according to the present invention can be applicable widely and economically. Furthermore, for a constant release voltage U_{L}, the brake can be provided more economically by itself, because the coil of the electromechanical operating element must be only designed on a voltage level and need not tolerate voltage fluctuation in the intermediate circuit 22. Preferably, the direct-current-voltage regulator 24 is configured as a downwards-regulator.

The emergency operation supplying device 35 comprises storage means 36 for storing electric energy, such as for example capacitor, supercaps and/or accumulators. The emergency operation supplying device 35 is directly connected with the intermediate circuit 22 such that electric energy can flow from the emergency operation supplying device 35 into the intermediate circuit 22 in case that the voltage of the intermediate circuit-voltage U_{ZK} drops under the emergency voltage U_{N} of the storage means 36. Further, one or two diodes 37 can be provided. In the normal operation, the storage means 36 can be charged from the intermediate circuit 22 by means of the charging unit 27.

The charging unit 27 can be controlled by a charging control system 26 via connector 40. The charging control system 26 can be directly integrated in the control unit 25 of the inverter unit 20 in an advantageous way. It is also considerable (as shown in FIG. 2) that the charging control system 26 is provided as an extra physical unit in the inverter unit 20. In order to be able to monitor the status and the emergency voltage U_{N} of the storage means 36, the storage means 36 can be short-circuited in case of interconnecting a defined load (resistor). Further, on the one hand the so-called chopper resistor 41, or alternatively an external test resistor 44 can be used.

The chopper resistor 41 is used in emergency to reduce excessive energy in the intermediate circuit 22 or to transform the excessive energy in the intermediate circuit 22 into heat. This is the case if the driving unit 7 is moved by the rotor blade 9 or by the wind pressure or the inertia of the rotor blade 9. Here, the asynchronous machine 6 is in an operation mode of a generator, and the inverted rectifier 23 acts as a rectifier and the produced energy is supplied into the intermediate circuit 22. Then, the chopper resistor 41 is switched by the control unit 25 or the charging control system 26 in the intermediate circuit 22 via connector 43 and a switch 42.

If the emergency operation supplying device 35 should be tested, the charging control system 26 closes the switch 42 or 45, thereby the storage means 36 is short-circuited via the chopper resistor 41 or the external test resistor 44. Here, a determined measurement voltage U_{Me} drops off on a measurement resistor 47, and the determined measurement voltage U_{Me} is representative for the voltage U_{N} of the emergency operation supplying device 35. The charging control system 26 captures the measurement voltage U_{Me} on the measurement resistor 47 and gives the charging unit 27 via connector 40 an instruction to charge the storage means 36 according to the level of the measurement voltage U_{Me}. If the measurement voltage U_{Me} suggests the failure of storage means 36, then the charging control system 26 returns an error message to the control unit 25 via connector 49. In this case, the control unit 25 will forward this error message to the control means of the wind turbine via the connector 28, thereby the wind turbine will be switched off if necessary.

The control unit 25 controls the inverted rectifier 23 for the operation of the asynchronous machine 6 and the direct-current-voltage regulator 24 so as to release the brake 5 and enable the driving unit 7, and the charging control system 26, and the charging unit 27, the switch 42 of the chopper resistor 41 and/or the switcher 45 of the external test resistor 44. Because of this extremely advantageous integration of the whole control process in the control unit 25 of the inverter unit 20, which also physically combines different functions in itself, a very beneficial features of the driving device 1 is achieved.

Continuing with this integration concept, the inverter unit 20 can have a temperature control system. Here, inputs for temperature sensors 50, 51, 52, 53, 54 and humidity sensors 59, 60 and control outputs for air conditioning devices and/or heating devices are provided at the control unit 25 of the inverter unit 20.

In FIG. 2, the hub 4 of the wind turbine is shown schematically, wherein the inverter unit 20 is disposed in a switch cabinet 3 in the hub 4. A temperature sensor 50 and a humidity sensor 59 are directly provided in the inverter unit 20. Therefore, the environment, which is vital for the converter 21, 23, the direct-current-voltage regulator 24, the charging unit 27 and the control unit 25, is constantly monitored so as to protect the sensitive electronic components from overheating and/or short-circuit and corrosion due to humidity. Further, an air conditioning device and/or heating device 55 is disposed in the switch cabinet 3 for cooling or warming the inverter unit 20. It is also considerable to dispose another temperature sensor 51 in the switch cabinet 3.

The emergency operation supplying device 35 is also provided in the hub 4, and has a temperature sensor 52 and a separate air conditioning device and/or heating device 38 for cooling or heating the emergency operation supplying device 35. The efficiency of a determined storage means is temperature sensitive, especially for accumulators, so that the implementation of an air conditioning device and/or heating device 38 with a temperature sensor 52 makes the emergency operation supplying device 35 essentially more fail-safe. The temperature control and manipulation of the emergency operation supplying device 35 is realized by the control unit 25 in the inverter unit 20.

Similarly, the control unit 25 can also monitor other components in the hub 4 with respect to the temperature. FIG. 1 gives that a lubricant device 56 is provided in the hub 4. The lubricant device is used to provide the components of the blade adjusting means 8, especially the pinion 13 and the sprocket 14 with lubricant (grease), so as to avoid excessive wear. Because of the temperature dependence of the viscosity of the lubricant, at least another temperature sensor 53 and a heating device 57 should be provided here, which are also connected with the control unit 25. The pump 58 of the lubricant device 57 can be also controlled by the control unit 25 via connector 48.

Preferably, a temperature sensor 54 and a humidity sensor 60, which are connected with inputs of the control unit 25 of the inverter unit 20, are provided in the hub 4, so as to be able to monitor the environment in the hub 4 as well.

For example, PT100 elements can be applied for obtaining temperature. The inverter unit 20 must have at least so many temperature inputs as different zones to be regulated or monitored.

An advantageous embodiment discloses to connect multiple sensors to the control unit 25 in a temporally switched way by means of a multiplexer. If, for example, a measurement module for eight temperature signals is provided in the control unit 25, and each sensor is scanned every 15 seconds, each temperature value is then updated every two minutes. However, this has no negative influence due to slow change of temperature.

The combinations of features disclosed in the described embodiments should not limit the present invention; rather, the features of different implementations are also combinable with each other.

Reference signs:

| | |
|---|---|
| 1. | driving device |
| 2. | supplying device |
| 3. | switch cabinet |
| 4. | hub |
| 5. | brake |
| 6. | asynchronous machine |
| 7. | driving unit |
| 9. | rotor blade |
| 10. | gear |
| 11. | shaft |
| 12. | shaft |
| 13. | pinion |
| 14. | sprocket |
| 15. | blade bearing |
| 16. | longitudinal axis |
| 20. | inverter unit |
| 21. | rectifier |
| 22. | direct-current-voltage intermediate circuit |
| 23. | inverted rectifier |
| 24. | direct-current-voltage regulator |
| 25. | control unit |
| 26. | charging control system |
| 27. | charging unit |
| 28. | connector |
| 29. | supply network |
| 30. | connector (rectifier) |
| 31. | connector (inverted rectifier) |
| 32. | connector (asynchronous machine) |
| 33. | connector (giver) |
| 34. | connector |
| 35. | emergency operation supplying device |
| 36. | storage means |
| 37. | diode |
| 38. | air conditioning device and/or heating device |
| 40. | connector |
| 41. | chopper resistor |
| 42. | switch |
| 43. | connector |
| 44. | test resistor |
| 45. | switcher |
| 46. | connector |
| 47. | measurement resistor |
| 48. | connector |
| 49. | connector |
| 50. | temperature sensor |
| 51. | temperature sensor |
| 52. | temperature sensor |
| 53. | temperature sensor |
| 54. | temperature sensor |
| 55. | air conditioning device and/or heating device |
| 56. | lubricant device |
| 57. | heating device |
| 58. | pump |
| 59. | humidity sensor |
| 60. | humidity sensor |
| ∪_{ZK} | direct voltage |
| ∪_{L} | release voltage |
| ∪_{N} | emergency voltage |
| ∪_{Me} | measurement voltage |

1. A driving device (1) for a rotor blade (9) of a wind turbine, comprising:
at least one electromechanical driving unit (7) with an asynchronous machine (6) for adjusting the rotor blade (9);
an electrically operable brake (5) disposed at the driving unit (7), for fixing or braking the driving unit (6)
an electrical supplying device (2), via which the asynchronous machine (6) is connectable with an three-phase power supply network;
wherein the supplying device (2) comprises a rectifier (21), an inverted rectifier (23) and a direct-voltage intermediate circuit (22);
and wherein the brake (5) is connected with the direct- voltage intermediate circuit (22) via a direct-voltage regulator (24).

2. A driving device (1) according to claim 1, wherein an emergency operation supplying device (35) is connected with the intermediate circuit (22) and can be charged from the intermediate circuit (22) by means of a charging unit (27) and a charging control system (26).

3. A driving device (1) according to claim 1, wherein the electrical supplying device (2) comprises a control unit (25) for controlling the direct-voltage regulator (24) and the charging control system.

4. A driving device (1) according to claim 3, wherein the control unit (25) is connected with temperature sensors (50, 51, 52, 53, 54) and humidity sensors (59, 60), and at least an air conditioning device and/or a heating device (38, 55, 57) is provided for cooling or warming the electrical supplying device (2) and/or the emergency operation supplying device (35), which are controllable via the control unit (35).

5. A driving device (1) according to claim 1, the electrical supplying device (2), the direct-voltage regulator (24), the control unit (25), the charging control system (26) and the charging unit (27) are disposed in an inverter unit (20).

6. An inverter unit (20), comprising a rectifier (21), an inverted rectifier (23), a direct- voltage intermediate circuit (22), wherein the intermediate circuit (22) can be powered via the rectifier (21), and wherein an asynchronous machine (6) of a driving unit (7) of a blade adjusting means of a wind turbine can be powered via the inverted rectifier (23), further comprising a direct-voltage regulator (24) for controlling an electrically operable brake (5) for the driving unit (7), and a control unit (25) for controlling the inverted rectifier (23) and the direct-voltage regulator (24), wherein the inverter unit (20) in combination with the rectifier (21), the inverted rectifier (23), the direct-voltage intermediate circuit (22), the direct-voltage regulator (24) and the control unit (24) is implemented as a physical unit.

7. An inverter unit (20) according to claim 6, characterized in that, the physical unit comprises a charging unit (27) and a charging control system (26) for charging and monitoring an external emergency operation supplying device (35).

8. An inverter unit (20) according to claim 6, wherein the physical unit comprises at least one temperature sensor (50) and a humidity sensor (59) for monitoring internal environment, and inputs for additional temperature sensors and/or humidity sensors (51, 52, 53, 54, 60) are further provided.

9. A switch cabinet (3) with an inverter unit (20), comprising a rectifier (21), an inverted rectifier (23), a direct- voltage intermediate circuit (22), wherein the intermediate circuit (22) can be powered via the rectifier (21), and wherein an asynchronous machine (6) of a driving unit (7) of a blade adjusting means of a wind turbine can be powered via the inverted rectifier (23), further comprising a direct-voltage regulator (24) for controlling an electrically operable brake (5) for the driving unit (7), and a control unit (25) for controlling the inverted rectifier (23) and the direct-voltage regulator (24), wherein the inverter unit (20) in combination with the rectifier (21), the inverted rectifier (23), the direct-voltage intermediate circuit (22), the direct-voltage regulator (24) and the control unit (24) is implemented as a physical unit.

10. A switch cabinet (3) according to claim 9, wherein the physical unit of the inverter unit comprises at least one temperature sensor (50) and a humidity sensor (59) for monitoring internal environment, and inputs for additional temperature sensors and/or humidity sensors (51, 52, 53, 54, 60) are further provided, the switch cabinet comprising an air conditioning device and/or a heating device (55) for cooling or warming the inverter unit (20).

11. A wind turbine with a machine room disposed on a tower and with a rotor rotatably disposed at the machine room, the wind turbine comprising a hub (3) and rotor blades (9) rotatably disposed at the hub (3), characterized in that, at least one driving device (1) is provided in the hub (3), the driving device comprising:
at least one electromechanical driving unit (7) with an asynchronous machine (6) for adjusting the rotor blade (9);
an electrically operable brake (5) disposed at the driving unit (7), for fixing or braking the driving unit (6)
an electrical supplying device (2), via which the asynchronous machine (6) is connectable with an three-phase power supply network;
wherein the supplying device (2) comprises a rectifier (21), an inverted rectifier (23) and a direct-voltage intermediate circuit (22);
and wherein the brake (5) is connected with the direct- voltage intermediate circuit (22) via a direct- voltage regulator (24).
